(19) United States
(12) Patent Application Publication
(10) Pub. No.: US 2011/0304273 A1
(43) Pub. Date: Dec. 15, 2011

(54) SECURITY LIGHTING SYSTEM

(75) Inventor: Richard G. Bennette, Boerne, TX (US)

(73) Assignee: CREATIVE INDUSTRIES, LLC, Boerne, TX (US)

(21) Appl. No.: 12/814,797

(22) Filed: Jun. 14, 2010

(51) Int. Cl. H05B 37/02

(52) U.S. Cl. 315/159

(57) ABSTRACT

A security lighting system includes a lighting fixture and a power source having an input electrical AC voltage and a rechargeable battery. A switch is selectively coupled to the lighting fixture and power source and is responsive to a motion sensor and a photo cell. A timer is associated with the switch to uncouple the power source from the lighting fixture after a predetermined time has elapsed since the motion sensor last detected a movement. A selector is associated with the switch having one of a plurality of modes of operation including an off, an extend, or a security mode of operation. The input electrical AC voltage is coupled either to a primary landscape lighting system or a solar power supply.

### BACKGROUND OF THE INVENTION

The present invention generally relates to lighting. More particularly, the present invention relates to a security lighting system that can be powered through a rechargeable battery and motion activated with a sensor when needed.

Landscape lighting, garden lighting, or outside lighting generally refers to the use of outside illumination to illuminate various landscape and architectural structures at night. During human history, outside structures and areas have been illuminated by campfires and torches, then gas or liquid powered lamps, and now currently with electricity-based methods such as light bulbs and neon lamps. For as long as humans have been around, we have used illumination methods to brighten the night.

Night-time illumination can serve several purposes. First, illumination can be aesthetically pleasing. Many homes, buildings, or structures use illumination at night even when people are not inside the structures. People who pass by can appreciate the aesthetic appeal of the various structures and the various ways light can be cast upon the structures. Illumination can also be directed towards safety, as it is hard to see at night. Illumination can help keep criminals away by exposing any attempted crime or wrongdoing, or the illumination can help one safely traverse a certain area. For instance, at night it is easy to trip or lose one's balance on uneven and unexpected changes of the walking surface. Landscape lighting can illuminate various walkways and make them safe for use.

In today's energy conscious world, it is always wise and desired to conserve and limit the use of energy such that it doesn't place and undue burden on our environment and resources. However, the need to safely light various areas remains. Certain areas which may require lighting may only need to do so when a passerby wants to traverse a remote walkway or area. It is uneconomical to constantly illuminate certain areas and walkways that are infrequently used. Also, this need to illuminate a certain area may be required when a traditional power line is unavailable, such as during a power outage.

Current motion sensing solar path lights are stand-alone units that have rechargeable batteries. These path lights cannot be attached to an existing power line/input electrical AC voltage or to an auxiliary solar panel. These path lights cannot store energy from an external power source to be later used if needed. These path lights cannot serve as traditional path/security lighting and cannot be selectively set to extend the operating time beyond that of the external power supply.

Accordingly, there is a need for a security lighting system that can activate when needed and turn off after use and receive power from an external power supply, whether that supply is from existing power lines or from an auxiliary solar power source. The present invention fulfills these needs and provides other related advantages.

### SUMMARY OF THE INVENTION

The security lighting system of the present invention includes a lighting fixture and a power source. The power source includes an input electrical AC voltage and a rechargeable battery. A motion sensor and a photo cell are associated with the lighting fixture for selectively coupling the power source to the lighting fixture. A switch is responsive to the motion sensor and photo cell for selectively conductively coupling the lighting fixture to either the input electrical AC voltage or the rechargeable battery. A timer is associated with the switch to uncouple the power source from the lighting fixture after a predetermined time has elapsed since the motion sensor last detected a movement. A selector is associated with the switch having one of a plurality of modes of operation including an off, an extend, and a security mode of operation. The off mode of operation does not allow the switch to couple the power source to the lighting fixture and does allow the rechargeable batteries to charge from the input electrical AC voltage. The extend mode of operation allows the switch to couple the rechargeable batteries to the lighting fixture after the input electrical AC voltage is terminated, such as during a power outage, until either the rechargeable batteries are depleted or the photo cell detects a daylight. Lastly, the security mode of operation allows the switch to couple the rechargeable batteries to the lighting fixture when the input electrical AC voltage is interrupted and the motion sensor detects a motion.

In an exemplary embodiment the input electrical AC voltage is coupled to a primary landscape lighting system. Alternatively, the input electrical AC voltage can be coupled to a solar power supply. The lighting fixture can be just a single lighting fixture or a plurality of lighting fixtures. The lighting fixture can use a traditional incandescent-type light bulb or equivalent bulb, or preferably utilize light emitting diodes. The motion sensor and the photo cell can either be integrally formed as part of the switch or alternatively formed separate from the switch and remotely placed. Many types of motion sensors can be used, and one such type is a passive infrared motion sensor. The switch, motion sensor, and photo cell can all be mounted upon a ground stake. The ground stake allows easy installation in a landscape while also protecting the electronics from weather and animals by supporting it off the ground level.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of an exemplary security lighting system embodying the present invention;

FIG. 2 is a schematic view of the exemplary security lighting system of FIG. 1; and

FIG. 3 is a perspective front view of the structure of FIG. 2 taken along line 3-3.

### DETAILED DESCRIPTION OF THE PREFERRED EMBODIMENTS

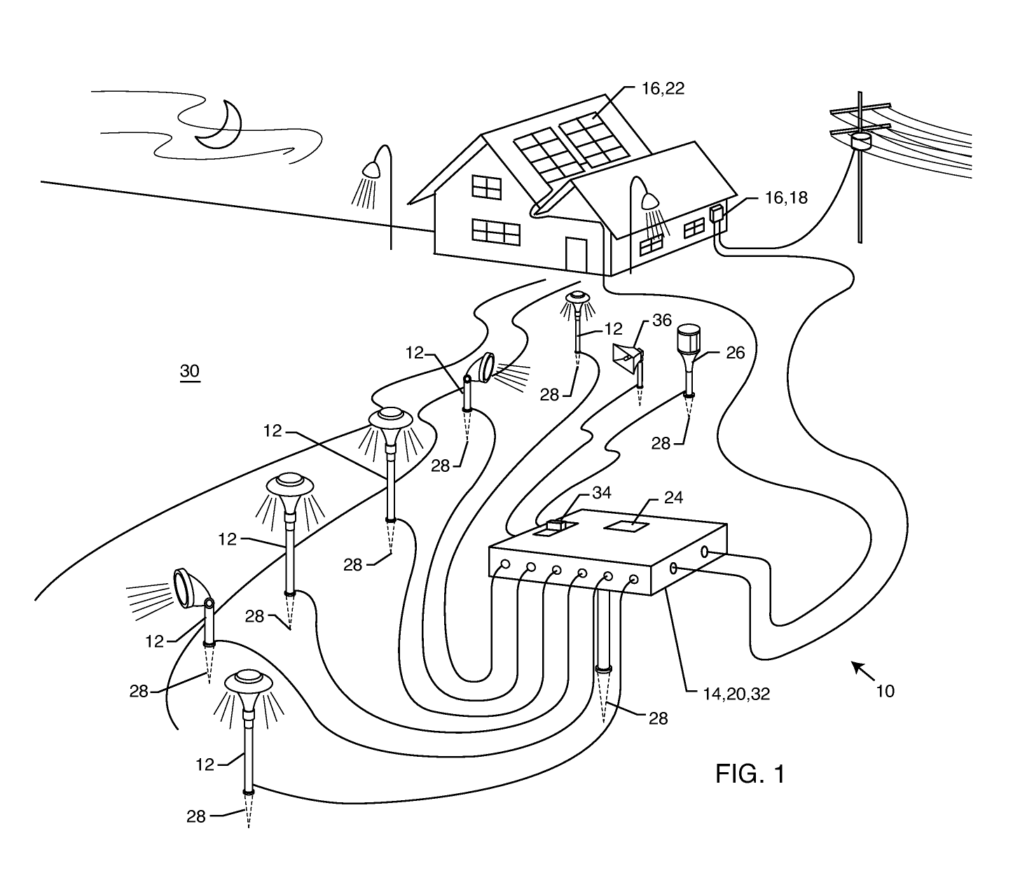

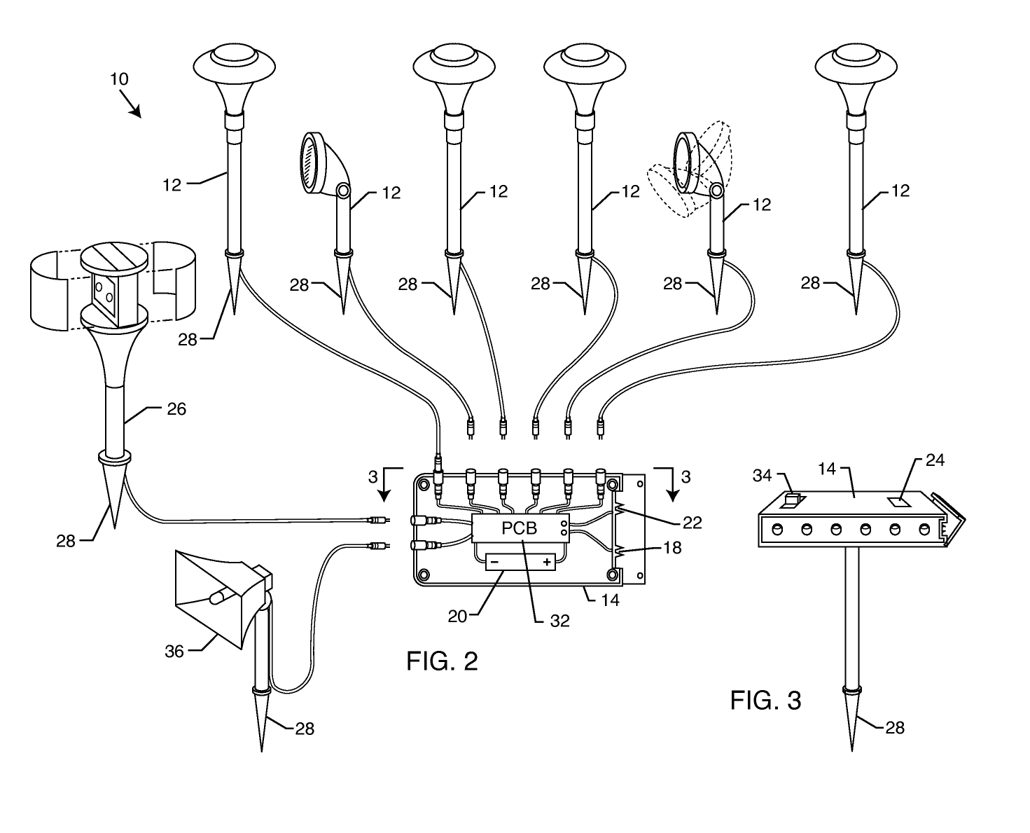

As shown in the drawings for purposes of illustration, the present invention for a security lighting system is referred to generally by the reference number 10. FIG. 1 is a perspective view of an exemplary security lighting system 10 embodying the present invention. FIG. 2 is a schematic view of the exemplary security lighting system 10 of FIG. 1. FIG. 3 is a perspective front view of the structure of FIG. 2 taken along line 3-3. The security lighting system 10 includes a lighting fixture 12 or a plurality of lighting fixtures 12. The lighting fixtures 12 can be any type of lighting fixtures such as ones that generally illuminate downward or spot lights that can be aimed and directed at a specific structure. The lighting fixtures 12 can use a traditional incandescent-type light bulb or equivalent bulb, or preferably utilize light emitting diodes. Light emitting diodes typically use a significantly smaller amount of power and last considerably longer than conventional bulbs. A switch 14 controls the operation of the lighting fixtures 12. The switch 14 uses circuitry to route electrical power from a power source 16 to the lighting fixtures 12.

The power source 16 can be an input electrical AC voltage 18 from a primary landscape lighting system. Typically, existing landscape lighting is configured to run off of a timer, such that the lights only come on at night and automatically turn off during the day. The switch 14 can receive power from the input electrical AC voltage 18 at night so that it can power the lighting fixtures 12. The power source 16 also includes rechargeable batteries 20. The power source 16 would directly supply electrical power to the lighting fixtures 12 while also trickle charging the batteries 20. Rechargeable batteries 20 supply power to the lighting fixtures 12 even if the input electrical AC voltage is cut, such as during a power outage. This also provides an added level of safety as cutting the power source 16 does not disable the security lighting system 10.

The power source 16 can also be from a solar power supply 22. The solar power supply 22 can be a multitude of types, including those installed on the roof of a dwelling or ones placed directly in the landscape. A compact and easily positionable solar power supply 22 can be ideal for remote locations where an input electrical AC voltage 18 is not accessible. The solar power supply 22 charges the rechargeable batteries 20 during the day such that at night the batteries 20 can provide power to the lighting fixtures 12. It is also possible to create a switch 14 that could accept both a power source 16 from the input electrical AC voltage 18 and from the solar power supply 22.

A photo cell 24 is in communication with the switch 14. The photo cell 24 allows the switch 14 to determine whether it is day or night (daylight). The switch 14 will not send electrical power to the lighting fixtures 12 in the day, but rather only at night when illumination is needed. The photo cell 24 can be formed integral to the switch 14, or in the alternate, be formed separate from the switch 14 and remotely placed.

A motion sensor 26 is also in communication with the switch 14. The motion sensor 26 can be any suitable type of sensor that can detect motion, such as a passive infrared motion sensor. The motion sensor 26 can then send a signal to the switch 14 when it detects a motion from a person passing close by. The switch 14 can then activate the lighting fixtures 12. The motion sensor 26 allows the lighting fixtures 12 to only illuminate when needed, to therefore save energy when it is not needed. The motion sensor 26 can be formed integral to the switch 14, or in the alternate, be formed separate from the switch 14 and remotely placed.

The switch 14, the photo cell 24, the motion sensor 26, and the lighting fixtures 12 are all installed in the outdoor environment. Accordingly, each device can be formed with a stake 28 that is designed to be pushed into the ground level 30. The stake 28 provides an easy way to install the various devices in the environment while also keeping the devices above the ground level 28. For instance, it is preferable that the devices remain approximately four inches above the ground level 30 to prevent the weather such as rain or debris from causing a disturbance. Additionally, keeping the devices raised can prevent them from tampering by insects, rodents, and other various varmints.

A timer 32 is also associated with the switch 14 to uncouple the power source 16 from the lighting fixtures 12 after a predetermined time has elapsed since the motion sensor 26 last detected a movement. The timer 32 can be integrated into a printed circuit board or the electronics of the switch 14. Once a motion has been detected, the lighting fixtures 12 can remain lit for a minute until the timer 32 allows the switch 14 to uncouple the power source 16. The duration of the timer 32 can be preset during assembly or adjusted by the user. The timer 32 will typically be formed as part of the circuitry and integral to the switch 14, but could alternatively be formed separate from the switch 14 and remotely placed.

A selector 34 is associated with the switch 14 having one of a plurality of modes of operation including an off, an extend, or a security mode of operation. The off mode of operation does not allow the switch 14 to couple the power source 16 to the lighting fixture 12 and does allow the rechargeable batteries 20 to charge from the input electrical AC voltage 18. The extend mode of operation allows the switch 14 to couple the rechargeable batteries 20 to the lighting fixture 12 after the input electrical AC voltage 18 is terminated, such as during a power outage, until either the rechargeable batteries 20 are depleted or the photo cell 24 detects a daylight. Lastly, the security mode of operation allows the switch 14 to couple the rechargeable batteries 20 to the lighting fixture 12 when the input electrical AC voltage 18 is interrupted and the motion sensor 26 detects a motion.

In an exemplary embodiment, a speaker 36 is associated with the switch 14. The speaker 36 would only activate in the security mode of operation and would be powered by the rechargeable batteries 20 when the input electrical AC voltage 18 was interrupted and the motion sensor 26 detected a motion. The speaker 36 can make a variety of sounds including warning sirens, audible alarms, or even verbal instructions and warnings. In other exemplary embodiments, the speaker 36 can be activated for various other reasons such as indicating a power outage previously occurred, the input electrical AC voltage 18 is low, the switch has been tampered with, or the photo cell 24 is failing. As can be understood by one skilled in the art, the speaker 36 can be utilized in a variety of methods.

As can be seen, the security lighting system 10 can be used in a multitude of locations. The security lighting system 10 can be used to light areas that are infrequently used yet are still desirable areas to provide illumination during those infrequent instances. The security lighting system 10 can be used to light pathways to and from select openings, such as the front door to a dwelling or business. As can be seen by one skilled in the art, the security lighting system 10 can utilized outdoors in many situations and this disclosure does not limit its use to those specific instances described herein. Also, the security lighting system 10 can even be used indoors, such as semi-open hangers and warehouses where traditional overhead lighting may not be provided or economically feasible.

Although several embodiments have been described in detail for purposes of illustration, various modifications may be made to each without departing from the scope and spirit of the invention. Accordingly, the invention is not to be limited, except as by the appended claims.

What is claimed is:

1. A security lighting system, comprising:
a lighting fixture;
a power source for the lighting fixture comprising an input electrical AC voltage and a rechargeable battery;
a motion sensor associated with the lighting fixture for selectively coupling the power source to the lighting fixture;
a photo cell associated with the lighting fixture for selectively coupling the power source to the lighting fixture;
a switch responsive to the motion sensor and photo cell for selectively conductively coupling the lighting fixture to either the input electrical AC voltage or the rechargeable battery; and
a timer associated with the switch to uncouple the power source from the lighting fixture after a predetermined time has elapsed since the motion sensor last detected a movement.

2. The system of claim 1, wherein the input electrical AC voltage is coupled to a primary landscape lighting system.

3. The system of claim 1, wherein the input electrical AC voltage is coupled to a solar power supply.

4. The system of claim 1, wherein the lighting fixture is a plurality of lighting fixtures.

5. The system of claim 1, including a selector associated with the switch having one of a plurality of modes of operation.

6. The system of claim 5, wherein the plurality of modes of operation comprise an off, an extend, and a security mode of operation.

7. The system of claim 6, wherein the off mode of operation does not allow the switch to couple the power source to the lighting fixture and does allow the rechargeable batteries to charge from the input electrical AC voltage, and the extend mode of operation allows the switch to couple the rechargeable batteries to the lighting fixture after the input electrical AC voltage is terminated until either the rechargeable batteries are depleted or the photo cell detects a daylight, and the security mode of operation allows the switch to couple the rechargeable batteries to the lighting fixture when the input electrical AC voltage is interrupted and the motion sensor detects a motion.

8. The system of claim 1, wherein the motion sensor is integrally formed as part of the switch.

9. The system of claim 1, wherein the motion sensor is formed separate from the switch and remotely placed.

10. The system of claim 1, wherein the photo cell is integrally formed as part of the switch.

11. The system of claim 1, wherein the photo cell is formed separate from the switch and remotely placed.

12. The system of claim 1, wherein the lighting fixture uses light emitting diodes.

13. The system of claim 1, wherein the motion sensor is a passive infrared motion sensor.

14. The system of claim 1, including a ground stake attached to the motion sensor.

15. The system of claim 1, including a ground stake attached to the switch.

16. The system of claim 15, wherein the switch is mounted above a ground level to prevent damage from weather and animals.

17. A security lighting system, comprising:
a lighting fixture;
a power source for the lighting fixture comprising an input electrical AC voltage and a rechargeable battery;
a motion sensor associated with the lighting fixture for selectively coupling the power source to the lighting fixture;
a photo cell associated with the lighting fixture for selectively coupling the power source to the lighting fixture;
a switch responsive to the motion sensor and photo cell for selectively conductively coupling the lighting fixture to either the input electrical AC voltage or the rechargeable battery;
a timer associated with the switch to uncouple the power source from the lighting fixture after a predetermined time has elapsed since the motion sensor last detected a movement; and
a selector associated with the switch having one of a plurality of modes of operation.

18. The system of claim 17, wherein the input electrical AC voltage is coupled either to a primary landscape lighting system or a solar power supply.

19. The system of claim 18, wherein the plurality of modes of operation comprise an off, an extend, and a security mode of operation where the off mode of operation does not allow the switch to couple the power source to the lighting fixture and does allow the rechargeable batteries to charge from the input electrical AC voltage, and the extend mode of operation allows the switch to couple the rechargeable batteries to the lighting fixture after the input electrical AC voltage is terminated until either the rechargeable batteries are depleted or the photo cell detects a daylight, and the security mode of operation allows the switch to couple the rechargeable batteries to the lighting fixture when the input electrical AC voltage is interrupted and the motion sensor detects a motion.

20. A security lighting system, comprising:
a plurality of lighting fixtures;
a power source for the lighting fixtures comprising an input electrical AC voltage and a rechargeable battery, where the input electrical AC voltage is coupled to either a primary landscape lighting system or a solar power supply;
a motion sensor associated with the lighting fixtures for selectively coupling the power source to the lighting fixtures;
a photo cell associated with the lighting fixtures for selectively coupling the power source to the lighting fixtures;
a switch responsive to the motion sensor and photo cell for selectively conductively coupling the lighting fixtures to either the input electrical AC voltage or the rechargeable battery;
a timer associated with the switch to uncouple the power source from the lighting fixtures after a predetermined time has elapsed since the motion sensor last detected a movement; and
a selector associated with the switch having one of a plurality of modes of operation for selectively controlling the switch.
